(19) United States
(12) Patent Application Publication
(10) Pub. No.: US 2017/0208458 A1
(43) Pub. Date: Jul. 20, 2017

(54) INTER-CELL COOPERATIVE TRANSMISSION-BASED TRANSMISSION AND RECEPTION METHOD

(71) Applicant: Electronics and Telecommunications Research Institute, Daejeon-si (KR)

(72) Inventors: Jung-Bin KIM, Seoul (KR); In Ho LEE, Anseong-si (KR)

(73) Assignee: Electronics and Telecommunications Research Institute, Daejeon-si (KR)

(21) Appl. No.: 15/407,568

(22) Filed: Jan. 17, 2017

(30) Foreign Application Priority Data
Jan. 18, 2016 (KR) 10-2016-0006018
Jun. 17, 2016 (KR) 10-2016-0075974

(51) Int. Cl. H04W 8/24; H04W 36/00; H04W 24/10; H04W 72/04

(52) U.S. Cl. CPC H04W 8/245; H04W 72/0446; H04W 36/0061; H04W 24/10

(57) ABSTRACT

An inter-cell cooperative transmission-based transmission and reception method is provided. According to an exemplary embodiment, the inter-cell cooperative transmission-based transmission and reception method includes acquiring data of a terminal from a macro base station without exchanging data between small base stations in an environment where an exchange of cooperation-related information between the small base stations or between the small base stations and the terminal is limited; and transmitting the control information and the data, which are acquired by the small base stations, to the terminal in a cooperative manner among the base stations.

### CROSS-REFERENCE TO RELATED APPLICATION(S)

This application claims the benefit under 35 USC §119(a) of Korean Patent Application Nos. 10-2016-0006018, filed on Jan. 18, 2016 and 10-2016-0075974 filed on Jun. 17, 2016 in the Korean Intellectual Property Office, the entire disclosure of which is incorporated herein by reference for all purposes.

### BACKGROUND

1. Field

The following description relates to a wireless communication technology, and more specifically, an inter-cell cooperative transmission technology.

2. Description of Related Art

In order to improve a transfer rate in a wireless communication system, technologies such as an adaptive modulation and coding (AMC) method and a scheduling method are used. In the AMC method, a transmitter adapts the modulation and coding rate according to a channel state. For example, in a poor channel state, the transmitter may lower the modulation and coding rate to achieve a target reception error rate, while in a good channel state, the transmitter increases the modulation and coding rate. The scheduling method is to selectively allocate wireless resources to receivers in a good channel state, taking into consideration the channel state of each receiver.

For the application of the AMC method and the scheduling method to an actual wireless communication system, a base station needs to provide each of selected terminals with AMC information (e.g., information about modulation and coding rate) and scheduling information (e.g., information about allocated frequency and time resources), for which the information is transmitted to each terminal through a control channel.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a transmission and reception method based on inter-cell cooperative transmission in an environment where an exchange of information between cells is limited in a wireless communication system including cooperating cells.

In one general aspect, there is provided (to be finalized)

Other features and aspects will be apparent from the following detailed description, the drawings, and the claims.

### BRIEF DESCRIPTION OF THE DRAWINGS

FIG. 1 is a diagram illustrating a configuration of a downlink sub-frame to which the present invention is applied.

FIG. 2 is a diagram illustrating a configuration of a downlink frame to which the present invention is applied.

FIG. 3 is a diagram illustrating a configuration of a wireless communication cellular system to which the present invention is applied.

FIG. 4 is a flowchart illustrating a process in which a second small base station is designated and the small base stations acquire data of a terminal from a macro base station.

FIG. 5 is a diagram illustrating a configuration of a frame group that includes a non-cooperative transmission frame and a cooperative transmission frame according to an exemplary embodiment of the present invention.

FIGS. 6 to 8 are diagrams illustrating a configuration of a frame group for cooperative transmission support according to various exemplary embodiments of the present invention.

FIG. 9 is a table showing arrangements of transmission frames and cooperative transmission frames in each frame group configuration according to an exemplary embodiment of the present invention.

FIG. 10 is a table showing arrangements of transmission frames and cooperative transmission frames in each frame group configuration according to another exemplary embodiment of the present invention.

FIG. 11 is a flowchart illustrating a process for cooperative transmission when a second small base station to cooperate with a first small base station has been determined, for which additional control information and frame configuration information for cooperative transmission support are not required.

FIG. 12 is a flowchart illustrating a process for adaptive cooperative transmission when a second small base station has been determined, a frame group configuration has been selected, and frame configuration information has been provided to a terminal.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

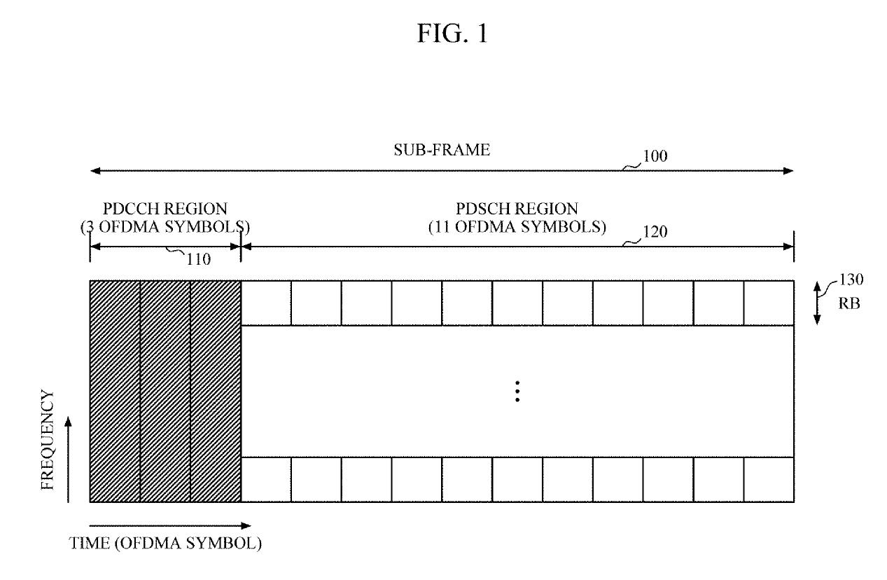

FIG. 1 is a diagram illustrating a configuration of a downlink sub-frame to which the present invention is applied.

To assist in understanding the present invention, the description will be provided with focus on an orthogonal frequency division multiple access (OFDMA)-based long term evolution (LTE) system, and the description may be applicable to any types of wireless communication systems in which cooperating cells are present.

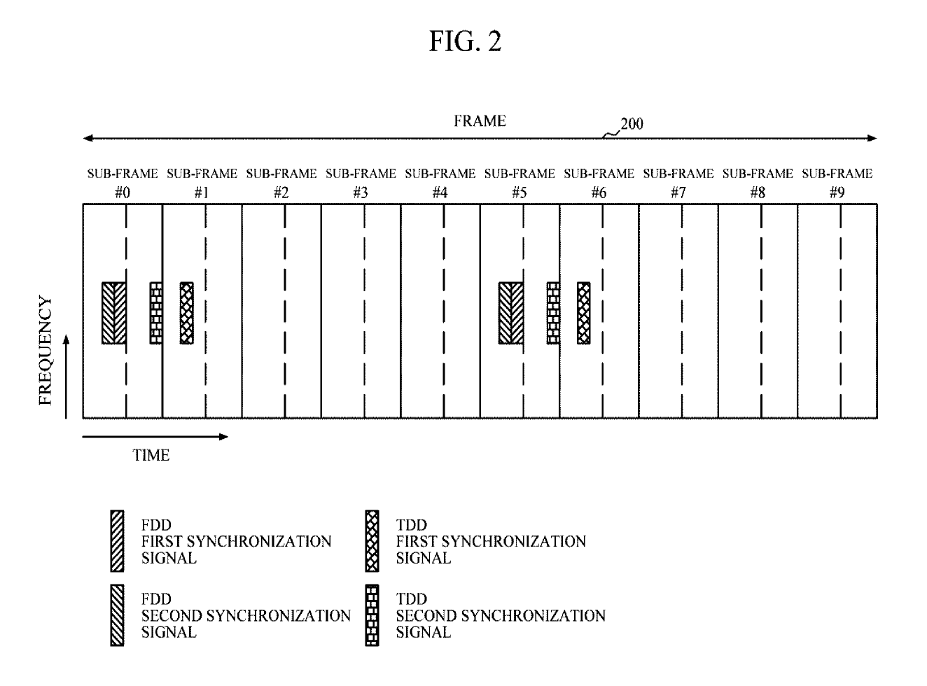

Referring to FIG. 1, one sub-frame 100 consists of fourteen OFDM symbols, and the first three OFDM symbols 110 correspond to a physical downlink control channel (PDCCH) region for control information transmission. The following symbols 120 correspond to a physical downlink shared channel (PDSCH) region for data transmission. The PDCCH region 110 is transmitted in a distributed manner across the entire system bandwidth, whereas the PDSCH region 120 is transmitted in units of resource blocks (RBs) 130. The RB is a unit of scheduling, each RB consists of 12 subcarriers, and the total number of RBs varies according to the system bandwidth. A base station transmits control information and data in units of sub-frames, and a terminal preferentially decodes the PDCCH region 110 and acquires its own adaptive modulation and coding (AMC) information and scheduling information. If the terminal fails to decode the PDCCH region 110, then it indicates that there is no data allocated to the pertinent sub-frame. FIG. 2 is a diagram illustrating a configuration of a downlink frame to which the present invention is applied.

To assist in understanding the present invention, the description will be described with focus on an LTE system, and still be applicable to any types of wireless communication systems in which cooperating cells are present.

Referring to FIG. 2, one frame 200 consists of a total of ten sub-frames, and at each frame, a first synchronization signal and a second synchronization signal are transmitted. The first and second synchronization signals are signals to be transmitted for synchronization between a base station and a terminal, and only when both the first and second synchronization signals are obtained, complete cell identifier (ID) information can be achieved. As shown in FIG. 2, in the LTE system, resources for transmission of a frequency division duplex (FDD) synchronization signal and a time division duplex (TDD) synchronization signal are differently allocated. This is because in the case of TDD, downlink sub-frames and uplink sub-frames are designated in one frame 200.

In a cellular mobile communication system, a received signal of a terminal which is located at the outskirts of cell coverage or obstructed by obstacles is of a poor quality due to the interference from a nearby base station. As a result, generally, such terminals placed at the edge of cell coverage or hidden by obstacles are provided with services at a lower transfer rate. To solve aforesaid problems, in the 4^{th} generation mobile communication technology, an inter-cell cooperative transmission technique has been introduced, in which adjacent base stations cooperate with each other to transmit data. According to the inter-cell cooperative transmission technique, a nearby interfering base station which cooperates with other base stations is allowed to transmit a signal while avoiding the interference, or to transmit a data signal of the interfered terminal, rather than an interference signal.

The inter-cell cooperative transmission technique includes a selective cell transmission scheme, a cooperative scheduling and beamforming scheme, a joint transmission scheme, etc. Each scheme requires an exchange of control information and data between cells. The selective cell transmission scheme and the joint transmission scheme require an exchange of data and control information between cells and synchronization between a cooperating base station and an interfered terminal in order for the cooperating base station to transmit data of said terminal. On the contrary, the cooperative scheduling and beamforming scheme is a scheme for interference avoidance, for which only an exchange of control information between cells is required. The exchange of data and control information between cells causes a time delay, which may lead to difficulties in smooth communication between a cooperating base station and a terminal. In addition, in the case where data transmission of the cooperating base station is required, synchronization between the cooperating base and the terminal needs to be considered, and hence control information exchange-based cooperative scheduling and beamforming scheme which incurs a relatively short time delay and requires no synchronization is used, or cooperative transmission among sections in the same base station is used. In this case, sectors in the same base station can share data and control information and hence no problems occur regarding information exchange between sectors. As such, the cooperative transmission between geographically distant base stations is actually limited in use due to the problems regarding the exchange of data and control information between base stations and synchronization. Therefore, the system design and transmission and reception method for the application of various cooperative transmission schemes to geographically distant base stations are required.

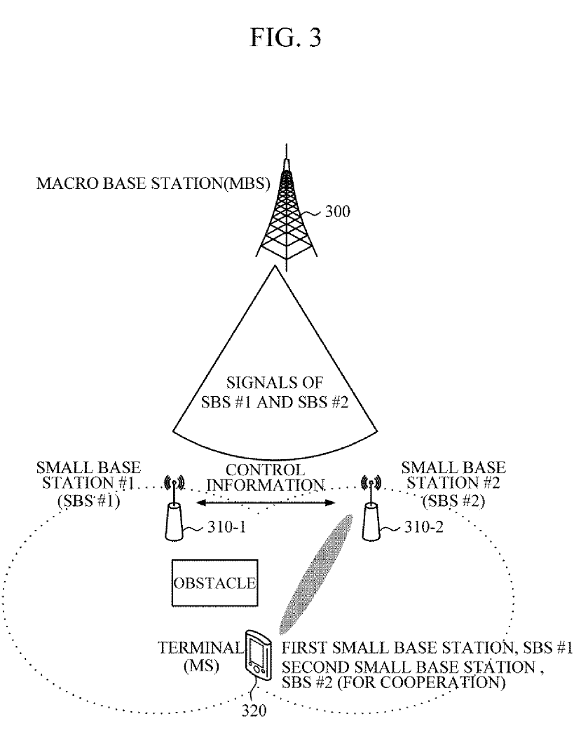

FIG. 3 is a diagram illustrating a configuration of a wireless communication cellular system to which the present invention is applied.

Referring to FIG. 3, the wireless communication cellular system includes a macro base station (MBS) 300, small base stations (SBSs) 310-1 and 310-2, and a terminal 320. In FIG. 3, for the convenience of description, only two small base stations are illustrated, but the number and form of small base stations are not limited thereto.

It is assumed that a link between the macro base station 300 and each of the small base stations 310-1 and 310-2 is referred to as a wireless back-haul link and a link between the terminal 320 and each of the small base stations 310-1 and 310-2 is referred to as an access link. If the macro base station 300 and the small base stations 310-1 and 310-2 are connected via a wired back-haul, the present invention is not limited to the wireless communication cellular system of FIG. 3, but is applicable to any wireless communication system in which cooperating cells are present.

It is assumed that the small base stations 310-1 and 310-2 are in an environment where an exchange of data and control information between base stations is limited. For example, the small base stations 310-1 and 310-2 may be actually geographically far from each other. The present invention provides a physical layer transmission frame configuration and transmission and reception method, for which data and control information are exchanged between base stations in a limited manner.

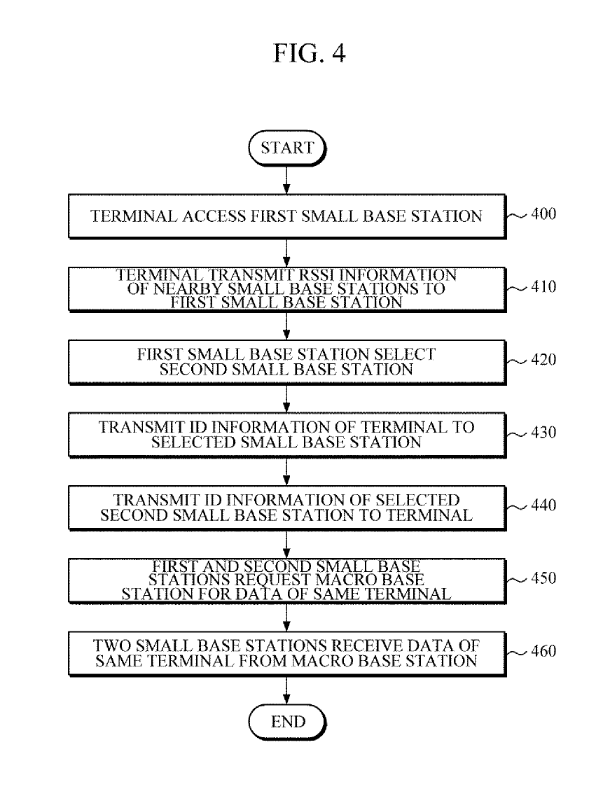

FIG. 4 is a flowchart illustrating a process in which a second small base station is designated and the small base stations acquire data of a terminal from a macro base station.

Referring to FIGS. 3 and 4, the terminal 320 accesses a first small base station SBS #1 301-1, as depicted in 400, measures a received signal strength indicator (RSSI) of a signal received from the nearby small base station, and transmits a report on the measured RSSI information to the first small base station SBS #1 310-1, as depicted in 410. The first small base station SBS #1 310-1 selects a second small base station SBS #2 310-2 using the received RSSI information, as depicted in 420. The second small base station SBS #2 310-2 may be a small base station that provides the highest RSSI among the reported RSSI information. The first base station SBS #1 310-1 sends identifier (ID) information of the pertinent terminal 320 to the second small base station SBS #2 310-2, as depicted in 430, and sends ID information of the selected second small base station SBS #2 310-2 to the terminal 320, as depicted in 440.

The first small base station 310-1 and the second small base station 310-2 associated with the terminal 320 request the macro base station 300 to send data of the terminal 320 based on the ID information of the terminal 320, as depicted in 450, and simultaneously receive the data of the terminal 320 using the same frequency resources via the wireless back-haul link, as depicted in 460. If the first and second small base stations 310-1 and 310-2 have difficulties in concurrently receiving the data of the terminal 320 using the same frequency resources, they may receive the data at different times or using different frequency resources. As such, the first and second small base stations 310-1 and 310-2 receive the data of the terminal 320 from the macro base station 300, without an exchange of data therebetween. Thus, only the control information needs to be exchanged between the first small base station 310-1 and the second small base station 310-2, and the second small base station 310-2 may transmit the data of the terminal 320 when cooperative transmission is needed.

The present invention suggests a frame group configuration for cooperative transmission support, which consists of the frames as described above with reference to FIG. 2. Hereinafter, the frame group configuration will be described with reference to the drawings.

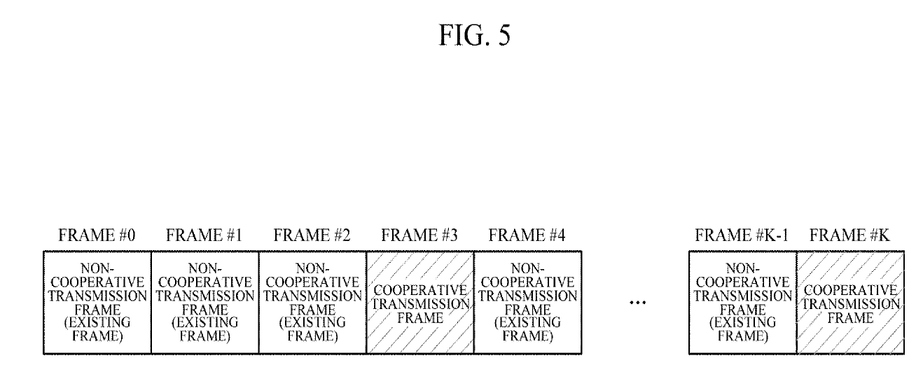

FIG. 5 is a diagram illustrating a configuration of a frame group that includes a non-cooperative transmission frame and a cooperative transmission frame according to an exemplary embodiment of the present invention.

Referring to FIG. 5, the frame group consists of K number of frames (where K is a positive integer), and each frame is classified as a non-cooperative transmission frame or a cooperative transmission frame. The cooperative transmission frame may be transmitted by both or either of the first and second small base stations. The reason for classifying each frame as a non-cooperative transmission frame or a cooperative transmission frame is to reduce the complexity of synchronization between the first and second small base stations and the terminal. The reason for designating the non-cooperative transmission frame and the cooperative transmission frame is to reduce the amount of control information exchanged between the first and second small base stations. That is, when the non-cooperative transmission frame and the cooperative transmission frame are fixed, the exchange of control information related to the cooperative transmission between the small base stations or between the small base stations and the terminal can be reduced. The frame group configuration suggested by the present invention may be determined according to the following three variables: a group size (the number of frames); a position of a cooperative transmission frame; and the number of cooperative transmission frames, while taking into consideration the number of terminals that request cooperative transmission, a service quality required by the terminal, etc. The frame group is a physical layer transmission frame.

The cooperative transmission frame may be transmitted and received using the following two methods.

Method 1: All terminals receive data only from the second small base station. Method 1 is applicable to a case where there are many terminals with a poor channel state from the first small base station, and the terminals do not require additional control information from the second small base station.

Method 2: A threshold value of a channel power between the first small base station and the terminal, a threshold value of a channel power between the second small base station and the terminal, and a threshold value of a ratio of a channel power between the first small base station and the terminal to a channel power between the second small base station and the terminal are determined by taking into consideration the service quality of the terminal, the determined threshold values are compared with actual channel power values, and according to the comparison result, one or all of the first and second small base stations may transmit control information and data in the cooperative transmission frame. In Method 2, the terminal is required to identify each case where only the first small base station transmits the control information and the data, only the second small base station transmits the same, or all the first and second small base stations transmit the control information and the data, and thus transmission mode identifier information needs to be transmitted to a control channel.

Hereinafter, exemplary embodiments of the present invention will be described.

### [First Exemplary Embodiment] Design of Frame Group for Cooperative Transmission Support and Method for Transmitting Group Information

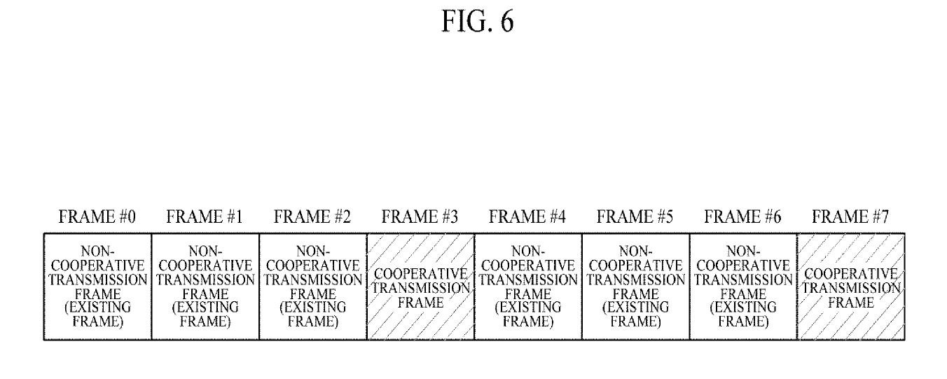

FIGS. 6 to 8 are diagrams illustrating a configuration of a frame group for cooperative transmission support according to various exemplary embodiments of the present invention.

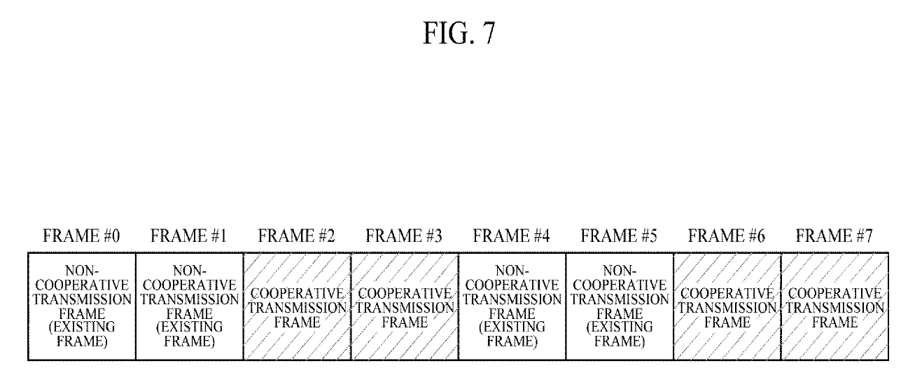

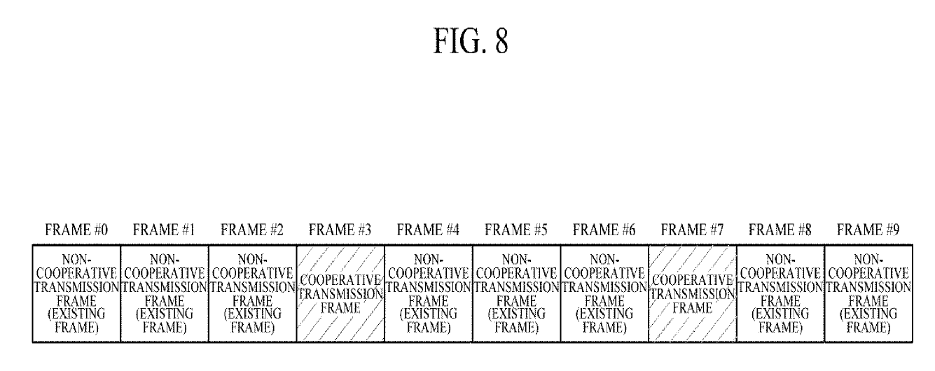

The configuration of FIG. 6 has a group size of 8 (i.e., consisting of eight frames), including two cooperative transmission frames placed at the fourth and eighth positions. The configuration of FIG. 7 has a group size of 8 (i.e., consisting of eight frames), including four cooperative transmission frames placed at the third, fourth, seventh, and eighth positions. The configuration of FIG. 8 has a group size of 10 (i.e., consisting of ten frames), including two cooperative transmission frames placed at the fourth and eighth positions. As such, the configuration of a frame group may be determined by taking into account the number of terminals that require the cooperative transmission, the services quality required by each terminal, etc.

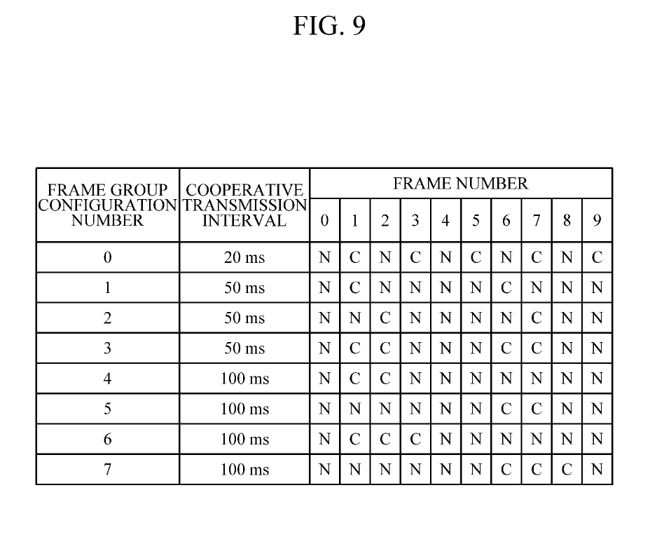

In order to apply the frame group configurations shown in FIGS. 6 to 8 to an actual wireless communication system, available cooperative transmission frame group configurations are determined in advance, and then can be used as shown in FIG. 9.

FIG. 9 is a table showing arrangements of transmission frames and cooperative transmission frames in each frame group configuration according to an exemplary embodiment of the present invention.

In FIG. 9, N denotes a non-cooperative transmission frame, C denotes a cooperative transmission frame, and an interval of one frame is assumed to be 10 ms. In FIG. 9, a total of eight frame group configurations are defined, and configuration information of each group is transmitted to a terminal from a small base station through upper signaling or a broadcast channel. Definitions of the frame group configurations may vary according to the size of a group or the positions and number of cooperative transmission frames, and accordingly the amount of configuration information may increase. However, such information is transmitted at very long intervals, and hence its impact on communication performance is negligible.

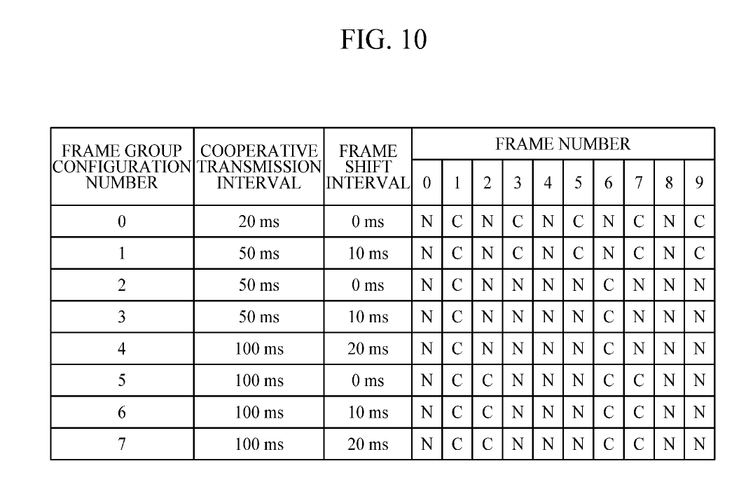

FIG. 10 is a table showing arrangements of transmission frames and cooperative transmission frames in each frame group configuration according to another exemplary embodiment of the present invention.

In FIG. 10, frame group configurations have different cooperative transmission intervals and different frame shift intervals. Here, the frame shift interval indicates an interval at which the cooperative transmission frame is moved as the frame group number increases, and the positions of cooperative transmission frames are cyclically shifted in the group. For example, in the case of frame group configuration number 0 in FIG. 10, the cooperative transmission frame numbers are fixed to 1, 3, 5, 7, and 9, regardless of the frame group number, while in the case of frame group configuration number 1, the cooperative transmission frame numbers are 1, 3, 5, 7, and 9 when the frame group configuration number is 0, and they are changed to 0, 2, 4, 6, and 8 when the frame group configuration number is 1. In this case, when the frame group configuration number increases to 2 and 3, the cooperative transmission frames are placed at the same positions as when the frame group configuration number is 0 and 1, respectively.

In FIG. 10, a total of eight frame group configurations are defined, and configuration information of each group is transmitted to a terminal from a small base station through upper signaling or a broadcast channel. Definitions of the frame group configurations may vary according to the size of a group or the positions and number of cooperative transmission frames, and accordingly, the amount of configuration information may increase. In addition, in order to share the definitions of the frame group configurations and information related to the group configurations, information about the group size, positions of the cooperative transmission frames, and an interval of cooperative transmission frame shift may be directly used, rather than using the configuration table, and said information may be transmitted from a small base station to the terminal through upper signaling or a broadcast channel. This information is transmitted at very long intervals, and hence its impact on communication performance is negligible.

### [Second Exemplary Embodiment] Cooperative Transmission Method that does not Require Additional Control Information from a Cooperative Transmission Frame

In the cooperative transmission frames of the frame group of the first exemplary embodiment, all terminals receive data from the second small base station. Therefore, the terminals do not require additional control information from the second small base station, and only perform synchronization with the second small base station.

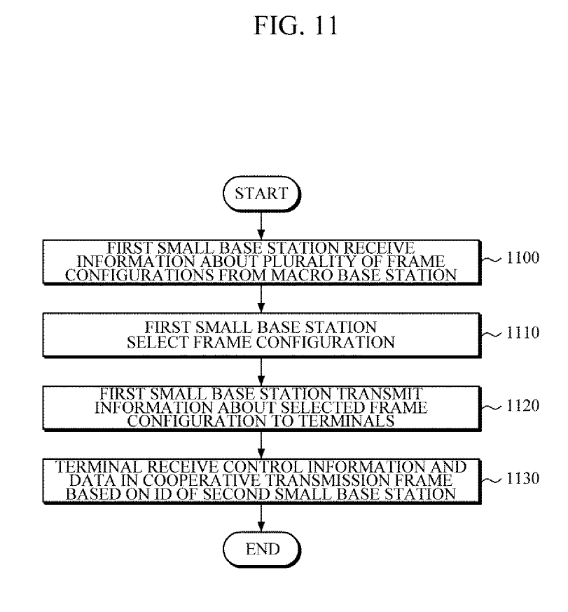

FIG. 11 is a flowchart illustrating a process for cooperative transmission when a second small base station to cooperate with a first small base station has been determined, for which additional control information and frame configuration information for cooperative transmission support are not required.

Referring to FIG. 11, the first small base station acquires information about frame configurations that includes various frame group sizes and the positions and numbers of cooperative transmission frames from a macro base station, as depicted in 1100. Then, the first small base station selects a frame configuration based on the acquired frame configuration information, taking into consideration the number of terminals that require the cooperative transmission and service qualities of each terminal, as depicted in 1110. Once selected the frame configuration, the first small base station transmits information about the selected frame configuration to the terminals through upper signaling, as depicted in 1120. Each terminal receives control information and data from the second small base station in the cooperative transmission frames based on the ID of the second small base station, as depicted in 1130.

### [Third Exemplary Embodiment] Adaptive Cooperative Transmission Method in Cooperative Transmission Frame

In the cooperative transmission frames of the frame group of first exemplary embodiment, the terminal can receive data from one or all of the first and second small base stations. As such, there are three modes in which only the first small base station transmits data, both the first and second small base stations transmit data, and only the second small base station transmits data, and a method for determining a transmission mode among the three modes and a method for transmitting information about the determined transmission mode to the terminal are as described below.

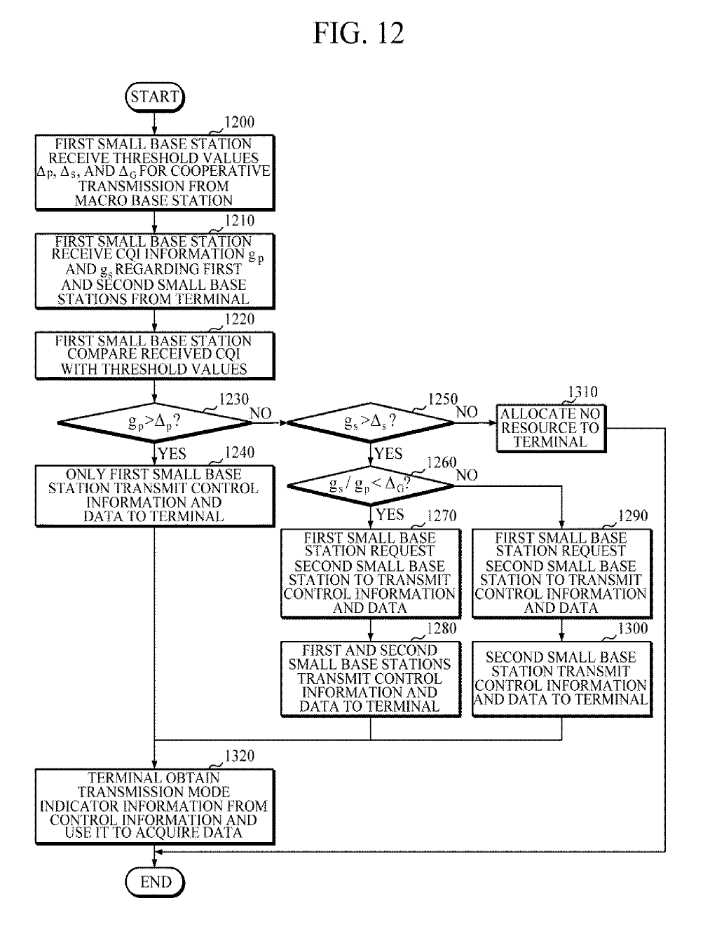

FIG. 12 is a flowchart illustrating a process for adaptive cooperative transmission when a second small base station has been determined, a frame group configuration has been selected, and frame configuration information has been provided to a terminal.

Referring to FIG. 12, a macro base station transmits threshold value information Δₚ, Δₛ, and Δ_{G} for determining a cooperative transmission mode to a first small base station through a wireless back-haul, as depicted in 1200. Here, Δₚ denotes a threshold value of a channel power between the first small base station and a terminal, Δₛ denotes a threshold value of a channel power between the second small base station and the terminal, and Δ_{G} denotes a threshold value of a ratio of a channel power between the first small base station and the terminal to a channel power between the second small base station and the terminal. These threshold values are determined by taking into consideration a service quality required by the terminal.

The first small base station receives gₚ and gₛ, which are channel quality indicators (CQIs) regarding the respective first and second small base stations, from the terminal, as depicted in 1210. Here, CQI information refers to information about a channel power value. Thereafter, the first small base station compares the CQI with the threshold values, as depicted in 1220, and selects the cooperative transmission mode as follows:

It is determined whether gₚ>Δₚ, as depicted in 1230, and if gₚ>Δₚ, it indicates that the service quality required by a channel state between the first small base station and the terminal is satisfied, and hence only the first base station transmits control information and data to the terminal, as depicted in 1240.

If gₚ<Δₚ, it is determined whether gₛ>Δₛ, as depicted in 1250, and if gₛ>Δₛ, it is determined whether gₛ/gₚ<Δ_{G}, as depicted in 1260. If gₛ>Δₛ, and gₛ/gₚ<Δ_{G}, the service quality required by a channel state between the first small base station and the terminal cannot be satisfied, the channel power between the second small base station and the terminal is greater than the threshold value Δₛ, and the ratio of the channel power between the first small base station and the terminal to the channel power between the second small base station is within Δ_{G}. Hence, when the first small base station requests the second small base station to transmit the control information and the data, as depicted in 1270, the first and second small base stations all transmit the control information and the data to the terminal, as depicted in 1280. This means that the powers received from the first and second small base stations are within a range that can mutually affect the performance improvement. For example, if a channel state of one of the two small base stations is far superior to another, the received power is determined by a power of the signal received from the small base station with the superior channel state.

If gₚ<Δₚ, gₛ>Δₛ, and gₛ/gₚ>Δ_{G}, the service quality required by the channel state between the first small base station and the terminal cannot be satisfied, the channel power between the second small base station and the terminal is greater than a threshold value Δₛ, and the channel state between the second small base station and the terminal is far better than the channel state between the first small base station and the terminal. Therefore, the first small base station requests the second small base station to transmit the control information and the data, as depicted in 1290, and only the second small base station transmits the control information and the data to the terminal, as depicted in 1300. If the above three cases are not applicable, resources are not allocated to the terminal, as depicted in 1310.

As described above, when the data is transmitted to the terminal after the cooperative transmission mode has been determined, the terminal needs to identify the transmission mode in order to acquire the data. Thus, in PDCCH, transmission mode indicator information needs to be transmitted by being added to AMC and scheduling information for each terminal. Then, the terminal obtains the transmission mode indicator information from the control information and uses it to acquire the data, as depicted in 1320.

When the first and second small base stations use different frequency bands, PDCCH is transmitted to the terminal over only a frequency band allocated to the small base station that transmits the data. When both the first and second small base stations transmit the data, the terminal receives PDCCH and PDSCH, respectively, over two different frequency bands, then combines two data signals, and decodes the combined signal.

According to the exemplary embodiments, in a wireless communication system in which cooperating cells are present, small base stations receives data of a terminal from a macro base station, without an exchange of data therebetween, and hence only an exchange of control information between the small base stations is required, so that the exchange of control information is reduced and synchronization between the small base stations and the terminal is not necessary.

In addition, the base stations transmit the control information and the data using a frame group configuration that contains cooperative transmission frames for cooperative transmission support, so that the complexity of synchronization between the small base stations and the terminal can be lowered and the amount of control information to be exchanged between the small base stations can be reduced. Furthermore, the cooperative transmission mode for the frame group configuration may allow the reduction in transmission power and improvement of received power performance.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An inter-cell cooperative transmission-based transmission and reception method comprising:
acquiring data of a terminal from a macro base station without exchanging data between small base stations in an environment where an exchange of cooperation-related information between the small base stations or between the small base stations and the terminal is limited; and
transmitting the control information and the data, which are acquired by the small base stations, to the terminal in a cooperative manner among the base stations.

2. The inter-cell cooperative transmission-based transmission and reception method of claim 1, wherein the acquiring of the data of the terminal comprises:
selecting, at a first small base station, a second small base station to cooperate with,
transmitting, at the first small base station, terminal identifier information to the selected second small base station, and
requesting, at the first and second small base stations, the macro base station to transmit terminal data using the terminal identifier information, and receiving the data.

3. The inter-cell cooperative transmission-based transmission and reception method of claim 2, wherein the selection of the second small base station comprises:
receiving, at the first small base station, a report on information about received signal strength indicators (RSSIs) of nearby base stations from a terminal that has accessed the first small base station, and
selecting, at the first small base station, a small base station with a highest RSSI from the reported RSSI information as the second small base station.

4. The inter-cell cooperative transmission-based transmission and reception method of claim 2, wherein the first and second small base stations simultaneously receive the data of the terminal from the macro base station through a wireless back-haul link by using same frequency resources, or the first and second small base stations receive the data of the terminal from the macro base station at different times by using different frequency resources.

5. An inter-cell cooperative transmission-based transmission and reception method comprising:
transmitting control information and data to a terminal in a cooperative manner between small base stations, by using a frame group configuration which contains cooperative transmission frames in an environment where an exchange of cooperation-related information between the small base stations or between the small base stations and the terminal is limited.

6. The inter-cell cooperative transmission-based transmission and reception method of claim 5, wherein the frame group configuration consists of K number of frames (where K is a positive integer), in which each frame is classified as a non-cooperative transmission frame or a cooperative transmission frame and the non-cooperative transmission frames and the cooperative transmission frames are fixed in positions.

7. The inter-cell cooperative transmission-based transmission and reception method of claim 5, wherein in the frame group configuration, a size of a frame group (a number of frames) and positions and number of cooperative transmission frames are determined using at least one of a number of terminals that require cooperative transmission and service qualities required by the terminals.

8. The inter-cell cooperative transmission-based transmission and reception method of claim 5, wherein the cooperative transmission frames are fixed at same positions in each frame group configuration or the cooperative transmission frames are cyclically shifted in each frame group configuration which has a different cooperative transmission interval and a different frame shift interval.

9. The inter-cell cooperative transmission-based transmission and reception method of claim 5, wherein a first small base station transmits the control information and the data in a non-cooperative transmission frame and at least one of the first small base station and a second base station selected by the first small base station transmits the control information and the data to the terminal in a cooperative transmission frame.

10. The inter-cell cooperative transmission-based transmission and reception method of claim 5, wherein the transmission of the control information and the data comprises:
setting a threshold value of a channel power between a first small base station and the terminal, a threshold value of a channel power between a second small base station and the terminal, and a threshold value of a ratio of the channel power between the first small base station and the terminal to the channel power between the second small base station and the terminal, and
transmitting, at both or either of the first and second small base stations, the control information and the data to the terminal in a cooperative transmission frame according to a result of comparing the set threshold values with actual channel power values.

11. The inter-cell cooperative transmission-based transmission and reception method of claim 5, wherein in the transmission of the control information and the data to the terminal, transmission mode indicator information is included in the control information and transmitted to the terminal so that the terminal can identify each case where only a first small base station transmits the control information and the data, both the first small base station and a second small base station transmit the control information and the data, or only the second small base station transmits the control information and the data.

12. An inter-cell cooperative transmission-based transmission and reception method comprising:
acquiring, at a first small base station, information about a plurality of frame configurations for cooperative transmission with a second small base station from a macro base station;
selecting, at the first small base station, a predetermined frame configuration using the acquired information about the plurality of frame configurations; and
transmitting, at the first small base station, information about the selected frame configuration to terminals.

13. The inter-cell cooperative transmission-based transmission and reception method of claim 12, wherein the first small base station selects the frame configuration based on the acquired information about the plurality of frame configurations, taking into consideration at least one of factors including the number of terminals that require cooperative transmission and service qualities of the terminals.

14. The inter-cell cooperative transmission-based transmission and reception method of claim 12, wherein the information about the plurality of frame configurations comprises at least one of a size of each frame group and positions and number of cooperative transmission frames in each frame configuration.

15. The inter-cell cooperative transmission-based transmission and reception method of claim 12, further comprising:
receiving, at each terminal, control information and data in a cooperative transmission frame of a frame configuration from a second small base station based on an identifier of the second small base station

16. The inter-cell cooperative transmission-based transmission and reception method of claim 12, further comprising:
in response to a second small base station being determined and a frame configuration being selected, providing, at a macro base station, a first small base station with a threshold value Δₚ of a channel power between the first small base station and the terminal, a threshold value Δₛ of a channel power between the second small base station and the terminal, and a threshold value Δ_{G} of a ratio of the channel power between the first small base station and the terminal to the channel power between the second small base station and the terminal, for determination of a cooperative transmission mode;
receiving, at the first small base station, channel quality indicator information gₚ regarding the first base station and channel quality indicator information gₛ regarding the second base station from the terminal; and
selecting, at the first small base station, the cooperative transmission mode by comparing the received channel quality indicator information with the threshold values.

17. The inter-cell cooperative transmission-based transmission and reception method of claim 16, wherein the threshold values are determined by taking into consideration a service quality required by the terminal.

18. The inter-cell cooperative transmission-based transmission and reception method of claim 16, wherein in the selection of the cooperative transmission mode, when gₚ>Δₚ, the first small base station transmits the control information and the data to the terminal.

19. The inter-cell cooperative transmission-based transmission and reception method of claim 16, the selection of the cooperative transmission mode comprises:
when gₚ<Δₚ, gₛ>Δₛ, and gₛ/gₚ<Δ_{G}, requesting, at the first small base station, the second small base station to transmit the control information and the data, and
transmitting, at the first small base station and the second small base station, the control information and the data to the terminal.

20. The inter-cell cooperative transmission-based transmission and reception method of claim 16, the selection of the cooperative transmission mode comprises
when gₚ<Δₚ, gₛ>Δₛ, and gₛ/gₚ>Δ_{G}, requesting, at the first base station, the second base station to transmit the control information and the data, and
transmitting, at the second small base station, the control information and the data to the terminal.
